(19) United States
(12) Patent Application Publication
(10) Pub. No.: US 2018/0121657 A1
(43) Pub. Date: May 3, 2018

(54) SECURITY RISK EVALUATION

(71) Applicant: INTERNATIONAL BUSINESS MACHINES CORPORATION, ARMONK, NY (US)

(72) Inventors: ROEE HAY, HERZLIYA (IL); OMER TRIPP, BRONX, NY (US); MARCO PISTOIA, YORKTOWN HEIGHTS, NY (US)

(21) Appl. No.: 15/339,965

(22) Filed: Nov. 1, 2016

(51) Int. Cl. G06F 21/57; G06F 21/51

(52) U.S. Cl. CPC G06F 21/577; G06F 2221/033; G06F 21/51

(57) ABSTRACT

A system for evaluating security risks including a processor to detect a set of vulnerabilities for an application based on static analysis of the application and calculate a risk score associated with each of the vulnerabilities based on additional characteristics of the application. The processor can also modify the application to prevent vulnerabilities with a risk score above a risk threshold value.

### BACKGROUND

The present disclosure relates to evaluating security risks, and more specifically, but not exclusively, to evaluating security risks for applications.

### SUMMARY

According to an embodiment described herein, a system for evaluating security risks comprises a processor to detect a set of vulnerabilities for an application based on static analysis of the application. The processor can also calculate a risk score associated with each of the vulnerabilities based on additional characteristics of the application. Furthermore, the processor can modify the application to prevent vulnerabilities with a risk score above a risk threshold value.

According to another embodiment, a method for evaluating security risks comprises detecting a set of vulnerabilities for an application based on static analysis of the application. The method can also include calculating a risk score associated with each of the vulnerabilities based on additional characteristics of the application. Furthermore, the method can include modifying the application to prevent vulnerabilities with a risk score above a risk threshold value.

According to another embodiment, a computer program product for evaluating security risks can include a computer readable storage medium having program instructions embodied therewith, wherein the computer readable storage medium is not a transitory signal per se. The program instructions can be executable by a processor to cause the processor to detect a set of vulnerabilities for an application based on static analysis of the application. The program instructions can also cause the processor to calculate a risk score associated with each of the vulnerabilities based on additional characteristics of the application and modify the application to prevent vulnerabilities with a risk score above a risk threshold value.

### BRIEF DESCRIPTION OF THE DRAWINGS

FIG. 1 depicts a block diagram of an example computing system that can evaluate security risks for an application according to an embodiment described herein;

FIG. 2 is a process flow diagram of an example method that can evaluate security risks for an application according to an embodiment described herein;

FIG. 3 is an example of a decision tree used to evaluate security risks of an application;

FIG. 4 is a tangible, non-transitory computer-readable medium that can evaluate security risks for an application according to an embodiment described herein;

FIG. 5 depicts an illustrative cloud computing environment according to an embodiment described herein; and

FIG. 6 depicts a set of functional abstraction layers provided by a cloud computing environment according to an embodiment described herein.

### DETAILED DESCRIPTION

Many software applications send and receive data using various internet protocols and websites. Therefore, software applications are increasingly exposed to various unauthorized attempts to access confidential information. However, manual auditing of software applications to detect potential threats is prohibitive due to the size and complexity of modern code bases, as well as their rich network of dependencies on third-party libraries. Furthermore, automated algorithms for detection of application-level vulnerabilities have thus far been highly specialized and limited to code and configuration files while failing to analyze other aspects of software applications corresponding to networks, storage layers, cryptographic protocols, and the like.

The embodiments described herein include techniques for detecting a set of vulnerabilities for an application based on static analysis of the application and calculating a risk score associated with each of the vulnerabilities based on additional characteristics, such as runtime characteristics, of the application or any additional information beyond the source code of the application. Furthermore, the embodiments described herein include modifying the application to prevent vulnerabilities with a risk score above a risk threshold value.

In some embodiments, techniques described herein can evaluate security risks of web applications that transmit data to/from a database. A security risk, as referred to herein, can include any vulnerability of an application that enables unauthorized access of confidential or secure information. For example, techniques described herein can include using static analysis to scan source code for an application to determine if there is flow of information out of a first database, through an application, and into a sensitive endpoint such as a second database, file system, or a web service, among others. If the incoming data from the first database is neither sanitized nor validated, then the techniques described herein can determine whether access to the first database is restricted to trusted parties and whether data inserted by these parties into the first database is first sanitized or validated.

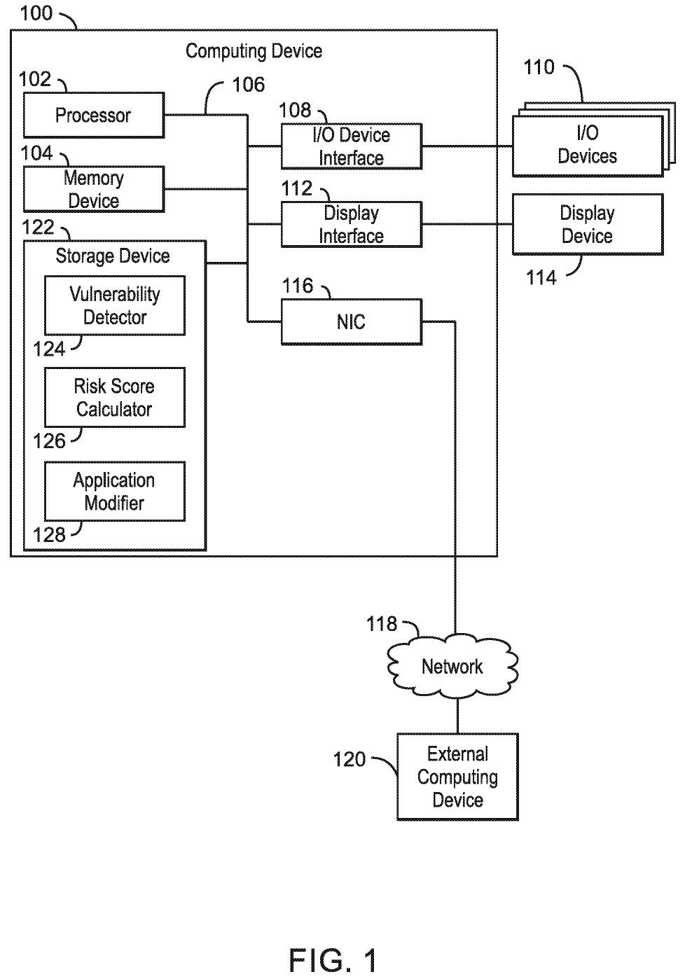

With reference now to FIG. 1, an example computing device is depicted that can evaluate security risks. The computing device 100 may be for example, a server, desktop computer, laptop computer, tablet computer, or smartphone. In some examples, computing device 100 may be a cloud computing node. Computing device 100 may be described in the general context of computer system executable instructions, such as program modules, being executed by a computer system. Generally, program modules may include routines, programs, objects, components, logic, data structures, and so on that perform particular tasks or implement particular abstract data types. Computing device 100 may be practiced in distributed cloud computing environments where tasks are performed by remote processing devices that are linked through a communications network. In a distributed cloud computing environment, program modules may be located in both local and remote computer system storage media including memory storage devices.

The computing device 100 may include a processor 102 that is adapted to execute stored instructions, a memory device 104 to provide temporary memory space for operations of said instructions during operation. The processor can be a single-core processor, multi-core processor, computing cluster, or any number of other configurations. The memory 104 can include random access memory (RAM), read only memory, flash memory, or any other suitable memory systems.

The processor 102 may be connected through a system interconnect 106 (e.g., PCI®, PCI-Express®, etc.) to an input/output (I/O) device interface 108 adapted to connect the computing device 100 to one or more I/O devices 110. The I/O devices 110 may include, for example, a keyboard and a pointing device, wherein the pointing device may include a touchpad or a touchscreen, among others. The I/O devices 110 may be built-in components of the computing device 100, or may be devices that are externally connected to the computing device 100.

The processor 102 may also be linked through the system interconnect 106 to a display interface 112 adapted to connect the computing device 100 to a display device 114. The display device 114 may include a display screen that is a built-in component of the computing device 100. The display device 114 may also include a computer monitor, television, or projector, among others, that is externally connected to the computing device 100. In addition, a network interface controller (NIC) 116 may be adapted to connect the computing device 100 through the system interconnect 106 to the network 118. In some embodiments, the NIC 116 can transmit data using any suitable interface or protocol, such as the internet small computer system interface, among others. The network 118 may be a cellular network, a radio network, a wide area network (WAN), a local area network (LAN), or the Internet, among others. An external computing device 120 may connect to the computing device 100 through the network 118. In some examples, external computing device 120 may be an external webserver 120. In some examples, external computing device 120 may be a cloud computing node.

The processor 102 may also be linked through the system interconnect 106 to a storage device 122 that can include a hard drive, an optical drive, a USB flash drive, an array of drives, or any combinations thereof. In some examples, the storage device may include a vulnerability detector 124 to detect a set of vulnerabilities for an application based on static analysis of the application. For example, the vulnerability detector 124 can analyze source code for the application to determine if a cross-site scripting vulnerability, a structured query language (also referred to herein as SQL) injection vulnerability, or any other suitable vulnerability exists. The storage device 122 can also include a risk score calculator 126 to calculate a risk score associated with each of the vulnerabilities based on runtime characteristics of the application. In some examples, the runtime characteristics can indicate whether databases accessed by the application are only accessible by trusted parties. Additionally, the storage device 122 can include an application modifier 128 to modify the application to prevent vulnerabilities with a risk score above a risk threshold value. For example, the application modifier 128 can add instructions to source code of an application to sanitize input including scripting characters, remove scripting characters from data retrieved from databases, and the like. Sanitizing, as referred to herein, includes any suitable technique for removing scripting characters from a set of data.

It is to be understood that the block diagram of FIG. 1 is not intended to indicate that the computing device 100 is to include all of the components shown in FIG. 1. Rather, the computing device 100 can include fewer or additional components not illustrated in FIG. 1 (e.g., additional memory components, embedded controllers, modules, additional network interfaces, etc.). Furthermore, any of the functionalities of the vulnerability detector 124, risk score calculator 126, and application modifier 128 may be partially, or entirely, implemented in hardware and/or in the processor 102. For example, the functionality may be implemented with an application specific integrated circuit, logic implemented in an embedded controller, or in logic implemented in the processor 102, among others. In some embodiments, the functionalities of the vulnerability detector 124, risk score calculator 126, and application modifier 128 can be implemented with logic, wherein the logic, as referred to herein, can include any suitable hardware (e.g., a processor, among others), software (e.g., an application, among others), firmware, or any suitable combination of hardware, software, and firmware.

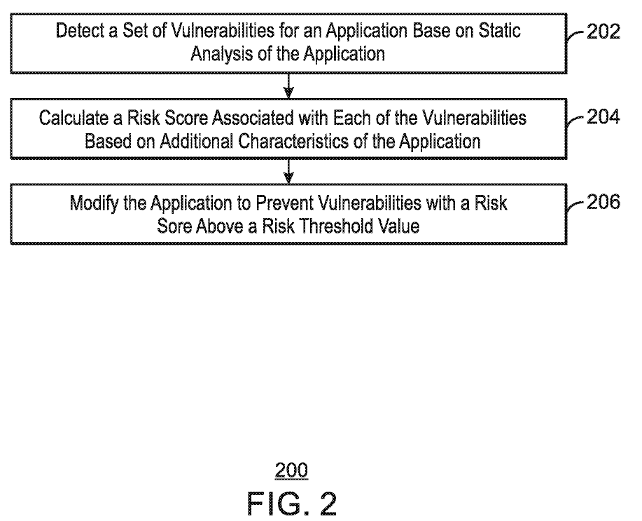

FIG. 2 is a process flow diagram of an example method that can evaluate security risks. The method 200 can be implemented with any suitable computing device, such as the computing device 100 of FIG. 1.

At block 202, a vulnerability detector 124 can detect a set of vulnerabilities for an application based on static analysis of the application. A vulnerability, as referred to herein, can include any portion of source code of an application that results in unauthorized access to confidential information, control of the application, and the like. In some examples, a vulnerability can include cross-site scripting vulnerabilities and structured query language (SQL) injection vulnerabilities. A cross-site scripting vulnerability can include a function call in source code of an application that retrieves information from a database or from user input. The application may display the retrieved information without determining if scripting characters are included in the retrieved information. Therefore, the application can display scripting commands that can enable malicious code to be executed by users who interact with the application. In some embodiments, a SQL injection vulnerability can include a function in source code of an application that stores information to a database without verifying that the information does not contain an apostrophe. For example, an application may receive user input and send the user input to a database. If the application does not determine if the user input includes scripting characters, then the application can store malicious scripts in the database. At a later time, other applications and devices can retrieve the malicious scripts, which can cause unauthorized access to the other applications and devices. In some embodiments, the static analysis can include taint propagation, among others.

At block 204, a risk score calculator 126 can calculate a risk score associated with each of the vulnerabilities based on various additional characteristics of the application. In some embodiments, the characteristics can include whether an application has access to confidential information, a number of lines of source code of an application, whether the application accesses a database with confidential information, and whether the vulnerability is located in web-pages with special characteristics, such as long pages, among others. For example, the risk score calculator 126 can determine that an application accesses a database with confidential information. Additionally, the risk score calculator 126 can determine based on static analysis that the application does not remove scripting characters from user input that is stored in the database. The risk score calculator 126 can aggregate the detected vulnerability from static analysis and the runtime characteristic of accessing a database with confidential information. In some embodiments, the risk score calculator 126 can calculate a risk score for each vulnerability based on a numerical scale, a probability that the vulnerability allows unauthorized access to confidential information, or by assigning a risk level or risk severity to vulnerabilities based on the runtime characteristics.

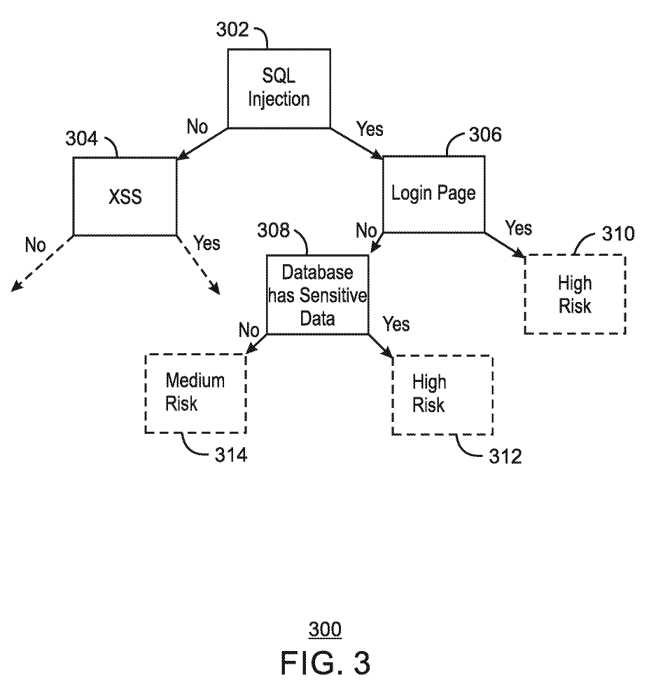

In some embodiments, the risk score calculator 126 can generate a decision tree based on each of the vulnerabilities detected from static analysis of the source code of the application and each of the additional characteristics. In some examples, the risk score calculator 126 can determine the risk score for each vulnerability by traversing a decision tree, wherein leaf nodes of the decision tree indicate the risk score. An example of a decision tree is described in greater detail below in relation to FIG. 3.

In some embodiments, the risk score calculator 126 can also detect the additional characteristics from a domain knowledge data repository. For example, the risk score calculator 126 can access a domain knowledge data repository to determine if an application accesses a database, if the application accepts user input, if the application stores confidential information, and the like. In some embodiments, the risk score calculator 126 can calculate the risk score based on input values detected during execution of the application. For example, the risk score calculator 126 can detect user input and combine the user input with the vulnerabilities identified during static analysis to determine a risk score for each vulnerability. In some embodiments, the risk score calculator 126 can calculate the risk score based on detected values generated by design tools during execution of the application.

At block 206, an application modifier 128 can modify the application to prevent vulnerabilities with a risk score above a risk threshold value. For example, the application modifier 128 can add instructions to source code of the application to sanitize or remove scripting characters from user input, data retrieved from databases, and data retrieved from other applications or services, among others. In some embodiments, the application modifier 128 can filter the vulnerabilities with associated risk scores below the risk threshold value.

The process flow diagram of FIG. 2 is not intended to indicate that the operations of the method 200 are to be executed in any particular order, or that all of the operations of the method 200 are to be included in every case. Additionally, the method 200 can include any suitable number of additional operations. For example, the risk score calculator 126 can also rank the set of vulnerabilities based on each risk score.

In one example, the vulnerability detector 124 can analyze source code for an application such as:

| | |
|---|---|
| 1 | String x = Database.query(“SELECT data from |
| 2 | temp”); |
| 3 | String user = getUser(x); |
| 4 | String pass = getPass(x); |
| 5 | |
| 6 | String t = Database.query(“SELECT * FROM users WHERE |

user = “ + user + “

| | |
|---|---|
| 7 | AND pass = “ + pass); |
| 8 | If (null != t) |
| 9 | { |

| | |
|---|---|
| 10 | .. proceed with login |

| | |
|---|---|
| 11 | } |

In some embodiments, the vulnerability detector 124 can detect a potential SQL injection vulnerability because there is a data-flow between potentially attacker-controllable input (line 1) to an SQL query construction (line 6). Since the static analysis does not provide information regarding whether the attacker can indeed control the data stored in the database (line 1), the security vulnerability can be theoretical. The risk score calculator 126 can detect additional sources of input, and according to a decision tree, for instance, compute the risk for the SQL injection vulnerability. For example, if the risk score calculator 126 can determine, based on detected user input, that the data is indeed controllable, then the risk of the vulnerability will be higher. In addition, in this example the SQL injection vulnerability results in a login bypass (line 6), so the evaluated risk also takes that into account. In some embodiments, the code can be modified so the vulnerability is mitigated.

FIG. 3 is an example of a decision tree used to evaluate security risks of an application. The decision tree 300 of FIG. 3 provides one example of an application with two identified vulnerabilities from static analysis of source code of an application. The vulnerabilities include a SQL injection vulnerability 302 and a cross-site scripting (XSS) vulnerability 304. In some examples, the risk score calculator 126 can generate the decision tree by identifying a first vulnerability as the head node of the decision tree and each additional vulnerability can be located either to the left or to the right of the head node as a child node. In some embodiments, the decision tree includes one vulnerability per level of the decision tree. The risk score calculator 126 can store a runtime characteristic opposite a vulnerability at each level of the decision tree. For example, the decision tree 300 includes runtime characteristics indicating an application has a login page 306 and an application accesses 308 a database with sensitive or confidential information.

In some embodiments, the risk score calculator 126 can determine a probability that a risk of unauthorized access to data exists for an application and an indication of the severity of the risk. For example, the decision tree 300 indicates that an application that includes a SQL injection vulnerability 302 and has a login page 306 has a high probability of risk 310 of enabling unauthorized access to data. Additionally, the decision tree 300 indicates that an application with a SQL injection vulnerability 302, no login page 306, and access to a database with sensitive or confidential data has a high risk 312 regarding enabling unauthorized access to data. In some examples, the decision tree 300 can indicate that an application with a SQL injection vulnerability 302, no login page 306, and no access to a database with sensitive or confidential data has a medium risk 314 regarding enabling unauthorized access to data. In some examples, the decision tree 300 can indicate a medium risk level for applications that do not appear to access databases with sensitive or confidential information. In some embodiments, the decision tree 300 can indicate if there is no SQL injection vulnerability 302 or a cross-site scripting vulnerability 304, then there is a low risk for the application to enable unauthorized access to data.

The decision tree 300 of FIG. 3 is not intended to indicate that all of the identified vulnerabilities for an application are to be included in every case. Furthermore, the decision tree 300 can include any suitable number of vulnerabilities and runtime or additional characteristics. In some embodiments, the decision tree 300 can include the risk score and severity of unauthorized data access as the leaf nodes of the decision tree. For example, the decision tree 300 can indicate that a denial of service vulnerability is a low risk for unauthorized access to confidential data. In some examples, a severity of a vulnerability is based on a vulnerability type, while a calculated risk includes a vulnerability type and additional characteristics.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

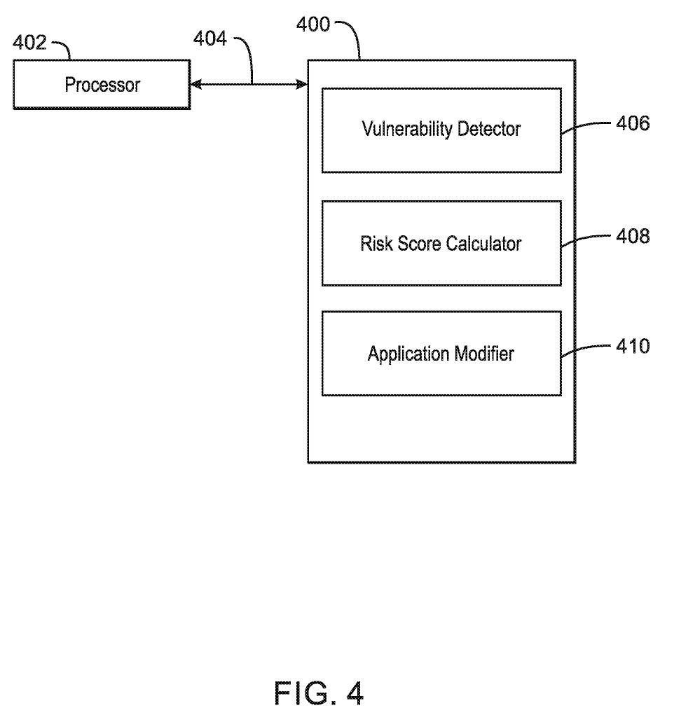

Referring now to FIG. 4, a block diagram is depicted of an example of a tangible, non-transitory computer-readable medium that can evaluate security risks. The tangible, non-transitory, computer-readable medium 400 may be accessed by a processor 402 over a computer interconnect 404. Furthermore, the tangible, non-transitory, computer-readable medium 400 may include code to direct the processor 402 to perform the operations of the current method. For example, a vulnerability detector 406 can detect a set of vulnerabilities for an application based on static analysis of the application. The computer-readable medium 400 can also include a risk score calculator 408 to calculate a risk score associated with each of the vulnerabilities based on runtime characteristics of the application. Additionally, the computer-readable medium 400 can include an application modifier 410 to modify the application to prevent vulnerabilities with a risk score above a risk threshold value.

It is to be understood that any number of additional software components not shown in FIG. 4 may be included within the tangible, non-transitory, computer-readable medium 400, depending on the specific application. Furthermore, fewer software components than those shown in FIG. 4 can be included in the tangible, non-transitory, computer-readable medium 400.

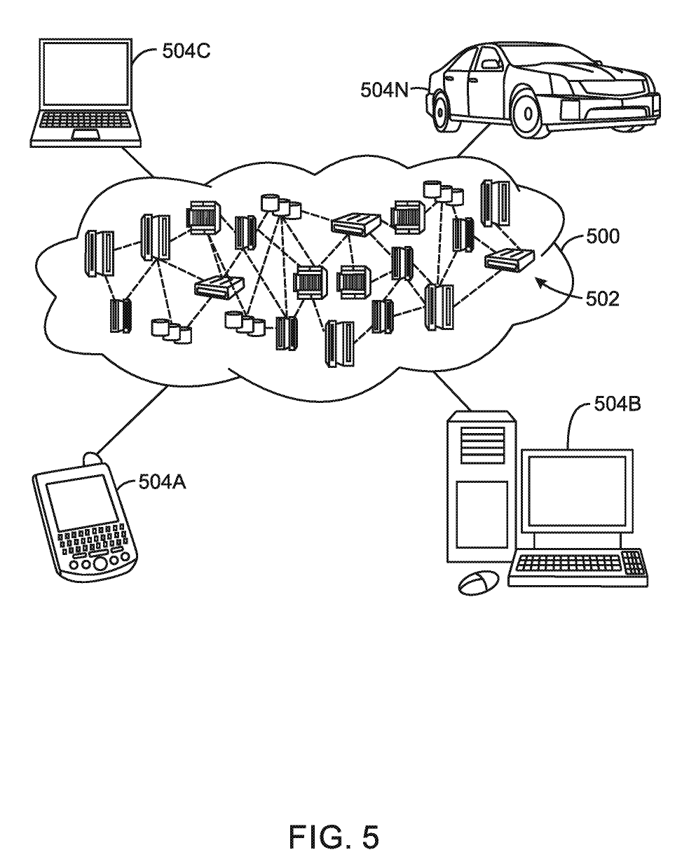

Referring now to FIG. 5, illustrative cloud computing environment 500 is depicted. As shown, cloud computing environment 500 comprises one or more cloud computing nodes 502 with which local computing devices used by cloud consumers, such as, for example, personal digital assistant (PDA) or cellular telephone 504A, desktop computer 504B, laptop computer 504C, and/or automobile computer system 504N may communicate. Nodes 502 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 504A-N shown in FIG. 5 are intended to be illustrative only and that computing nodes 502 and cloud computing environment 500 can communicate with any type of computerized device over any type of network and/or network addressable connection (e.g., using a web browser).

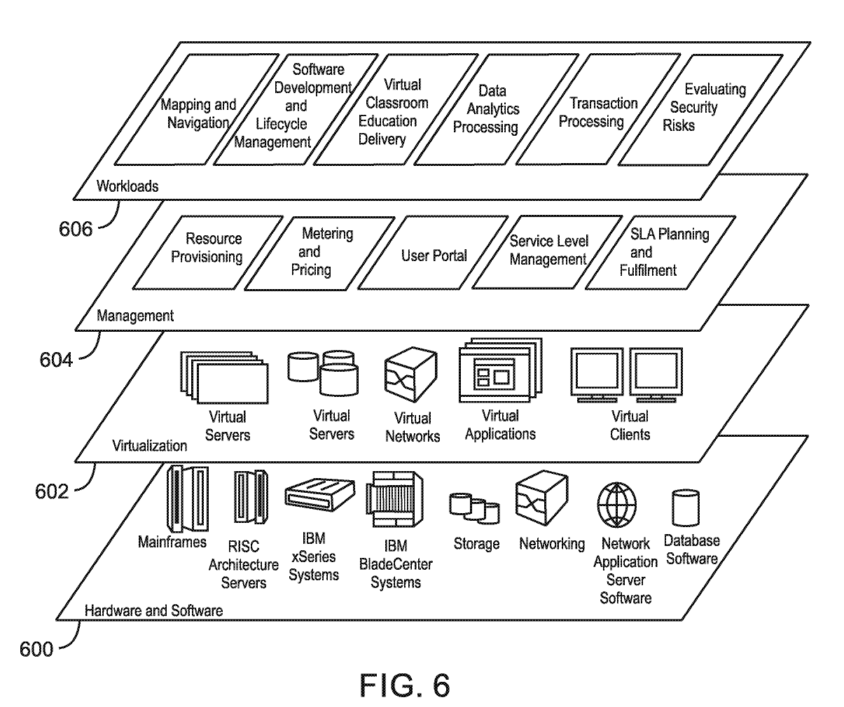

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided.

Hardware and software layer 600 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 602 provides an abstraction layer from which the following examples of virtual entities may be provided: virtual servers; virtual storage; virtual networks, including virtual private networks; virtual applications and operating systems; and virtual clients. In one example, management layer 604 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 606 provides examples of functionality for which the cloud computing environment may be utilized. Examples of workloads and functions which may be provided from this layer include: mapping and navigation; software development and lifecycle management; virtual classroom education delivery; data analytics processing; transaction processing; and evaluating security risks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for evaluating security risks comprising:
a processor to:
detect a set of vulnerabilities for an application based on static analysis of the application;
calculate a risk score associated with each of the vulnerabilities based on additional characteristics of the application; and
modify the application to prevent vulnerabilities with a risk score above a risk threshold value.

2. The system of claim 1, wherein the processor is to detect the additional characteristics from a domain knowledge data repository.

3. The system of claim 1, wherein the set of vulnerabilities comprises a cross-site scripting vulnerability.

4. The system of claim 1, wherein the set of vulnerabilities comprises a structured query language (SQL) injection vulnerability.

5. The system of claim 1, wherein the processor is to determine the risk score for each vulnerability by traversing a decision tree based on the domain knowledge data repository, wherein leaf nodes of the decision tree indicate the risk score.

6. The system of claim 1, wherein the processor is to calculate the risk score based on input values detected during execution of the application.

7. The system of claim 1, wherein the processor is to calculate the risk score based on detected values generated by design tools during execution of the application.

8. The system of claim 1, wherein the processor is to rank the set of vulnerabilities based on each risk score.

9. The system of claim 1, wherein the processor is to filter the vulnerabilities with associated risk scores below the risk threshold value.

10. A method for evaluating security risks comprising:
detecting, via a processor, a set of vulnerabilities for an application based on static analysis of the application;
calculating, via the processor, a risk score associated with each of the vulnerabilities based on additional characteristics of the application; and
modifying, via the processor, the application to prevent vulnerabilities with a risk score above a risk threshold value.

11. The method of claim 10, comprising detecting the additional characteristics from a domain knowledge data repository.

12. The method of claim 10, wherein the set of vulnerabilities comprises a cross-site scripting vulnerability.

13. The method of claim 10, wherein the set of vulnerabilities comprises a structured query language (SQL) injection vulnerability.

14. The method of claim 10, comprising determining the risk score for each vulnerability by traversing a decision tree based on the domain knowledge data repository, wherein leaf nodes of the decision tree indicate the risk score.

15. The method of claim 10, comprising calculating the risk score based on input values detected during execution of the application.

16. The method of claim 10, comprising calculating the risk score based on detected values generated by design tools during execution of the application.

17. A computer program product for evaluating security risks, the computer program product comprising a computer readable storage medium having program instructions embodied therewith, wherein the computer readable storage medium is not a transitory signal per se, the program instructions executable by a processor to cause the processor to:
detect a set of vulnerabilities for an application based on static analysis of the application;
calculate a risk score associated with each of the vulnerabilities based on additional characteristics of the application; and
modify the application to prevent vulnerabilities with a risk score above a risk threshold value.

18. The computer program product of claim 17, wherein the program instructions cause the processor to detect the additional characteristics from a domain knowledge data repository.

19. The computer program product of claim 17, wherein the set of vulnerabilities comprises a cross-site scripting vulnerability.

20. The computer program product of claim 17, wherein the set of vulnerabilities comprises a structured query language (SQL) injection vulnerability.
